(19) United States
(12) Patent Application Publication
(10) Pub. No.: US 2024/0270180 A1
(43) Pub. Date: Aug. 15, 2024

(54) Cladding Part for a Vehicle, and Vehicle

(71) Applicant: Bayerische Motoren Werke Aktiengesellschaft, Muenchen (DE)

(72) Inventors: Bernhard SCHMID, Hallbergmoos (DE); Fredrik SVEDBERG, Muenchen (DE)

(21) Appl. No.: 18/435,345

(22) Filed: Feb. 7, 2024

(30) Foreign Application Priority Data
Feb. 9, 2023 (DE) 10 2023 103 110.4

(51) Int. Cl. B60R 13/02

(52) U.S. Cl. CPC B60R 13/0243

(57) ABSTRACT

A cladding part for a vehicle, in particular for an interior of a vehicle, includes a base support and a fastening element for fastening the base support to a vehicle part of the vehicle. The fastening element is designed to pivot into a fastening position. A vehicle has a cladding part of this kind.

### CROSS REFERENCE TO RELATED APPLICATION

This application claims priority under 35 U.S.C. § 119 from German Patent Application No. 10 2023 103 110.4, filed Feb. 9, 2023, the entire disclosure of which is herein expressly incorporated by reference.

### BACKGROUND AND SUMMARY

The present invention relates to a cladding part for a vehicle, in particular for an interior of a vehicle, the cladding part having a base support and a fastening element for fastening the base support to a vehicle part of the vehicle. The invention also relates to a vehicle having at least one cladding part of this kind.

A cladding part of the kind mentioned at the outset is used, for example, for cladding a vehicle door. A cladding part of this kind usually has a base support on which a large number of components, such as door handles, armrests, map pockets or fastening elements for example, are fastened. The base support itself is fastened to an internal door panel.

For the purpose of fastening the cladding part to an internal door panel, DE 10 2019 133 551 A1 discloses providing fastening elements in the form of hooks on the base support of the cladding part, it being possible for the cladding part to be hooked into the vehicle door by means of the fastening elements.

In addition, it is known to design the fastening element as a fitting strip which is fitted in a channel seal of a vehicle door.

However, a fastening element designed as a fitting strip has the disadvantage that it has an undercut. However, an undercut is difficult to demold or cannot be demolded at all. In addition, very large and complex slides are required in the injection mold for demolding purposes.

In order to avoid these disadvantages, it is known to manufacture the fitting strip as a separate component and to cohesively connect it, for example by welding, to the base support. However, the separate component results in high costs since a separate injection mold is required for the separate component.

The present invention is based on the object of providing a cladding part and a vehicle which allow improved and cost-effective manufacture.

A first aspect of the invention proposes a cladding part for a vehicle, in particular for an interior of a vehicle, the cladding part having a base support and a fastening element for fastening the base support to a vehicle part of the vehicle, the fastening element being designed to pivot into a fastening position, in particular for fastening to the vehicle part.

Since the fastening element can be pivoted into a fastening position for fastening to a vehicle part, the fastening element can be produced, in particular injection-molded, in a manufacturing tool of the base support, for example an injection mold for the base support, in such a way that, in spite of undercuts being present on the fastening element, no slides are required in the tool or mold and/or that demolding of the fastening element is possible. After the manufacture, in particular the injection molding, of the base support, the fastening element can be pivoted, in particular flipped, into the fastening position for fastening to a vehicle part and can be fastened to the vehicle part in this position. In this way, the cladding part allows improved and cost-effective manufacture.

The cladding part may be a door cladding for a vehicle, in particular for an interior of a vehicle.

Further components, such as door openers, handles, armrests, window opener switches and/or textiles which improve the optical appearance for example, can also be integrated on the base support. The cladding part can serve as an internal door cladding which is fastened to an internal door panel of a vehicle door. In particular, the cladding part is fastened to a channel seal which is formed between an outer door panel and the internal door panel, in particular fitted into the channel seal.

The fastening element advantageously allows an interlocking and/or force-fitting connection to a vehicle part.

In one advantageous refinement, the fastening element is produced during the manufacture of the base support. For example, both the base support and the fastening element can be produced by molding, in particular by injection molding. The fastening element is advantageously connected to, in particular injection-molded onto, an edge, in particular a sill edge, of the base support.

The fastening element advantageously projects perpendicularly from an edge, in particular a sill edge, of the base support. The fastening element also advantageously bears against the base support, in particular a sill edge of the base support, in the fastening position.

In one advantageous refinement, the fastening element and/or the base support have/has a joint, the fastening element being pivotably connected to the base support by means of the joint. The joint is advantageously arranged on a sill edge of the base support. A thickness of the sill edge can be adjusted in the direction of a vehicle vertical axis, which corresponds to a Z axis, by means of a fold geometry of the fastening element. As a result, the waviness and the stiffness of the cladding part can be adjusted.

The fastening element is advantageously cohesively connected to the base support by means of the joint. A connecting point of the fastening element to the base support, in particular to the sill edge of the base support, and/or a connecting point of the base support, in particular the sill edge of the base support, to the fastening element further advantageously serve/serves as a joint. The fastening element and/or the base support have/has a reduced material thickness in the region of the connecting point, as a result of which the joint is formed. The joint is advantageously designed as a bending point and/or as a hinge.

In one advantageous refinement, the fastening element is injection-molded onto the base support. As a result, the pivotable fastening element is produced during injection molding of the base support. Owing to the pivotability of the fastening element, the fastening element can be injection-molded onto the base support without large and complex slides being required in the injection mold and demolding problems arising. The fastening element is advantageously injection-molded onto an edge, in particular a sill edge, of the base support. In addition, owing to the injection molding of the fastening element onto the base support, the joint, by means of which the fastening element is pivotably arranged on the base support, is formed at the same time.

In one advantageous refinement, the joint is produced by way of the fastening element having a lower material thickness in the connecting region to the base support, in particular to an edge of the base support, further in particular to the sill edge of the base support. A bending point or a hinge is produced as a result, it being possible for the fastening element to be pivotable or flipped by means of the bending point or hinge.

In one advantageous refinement, the fastening element is welded to the base support in the fastening position. As a result, the fastening element is fixedly connected to the base support in the fastening position. This prevents the fastening element changing its position or even pivoting back into the starting position in the fastening position. The fastening element is advantageously welded to the sill edge of the base support, in particular a bottom side of the sill edge.

In one advantageous refinement, the fastening element is connected to the base support by means of ultrasonic, vibration and/or mirror welding. These welding processes allow cohesive connection of the fastening element to the base support in areas that are difficult to access, such as beneath a projecting edge, in particular a sill edge of the base support, for example.

In one advantageous refinement, the fastening element is clipped and/or latched to the base support in the fastening position. The clipping and/or latching provide/provides simple and cost-effective connection of the fastening element to the base support in the fastening position and reliably prevent/prevents changing of the position of the fastening element in the fastening position and/or pivoting of the fastening element back into the starting position. The fastening element and/or the base support advantageously have/has openings in which latching elements, such as latching hooks for example, formed on the base support and/or the fastening element latch or lock when the fastening element is pivoted into the fastening position. In addition or as an alternative, the base support and/or the fastening element can have latching means, such as latching hooks for example, which engage around an edge, in particular a bottom edge, of the base support and/or the fastening element in order to hold the fastening element in the fastening position.

In one advantageous refinement, the fastening element is designed as a fitting strip for fitting into a mating element of the vehicle part. The mating element can be a channel seal, which is formed between the external door panel and the internal door panel and in which the fitting strip is fitted.

In one advantageous refinement, the fitting strip has a base plate, which is pivotably arranged on the base support, and two webs, which project from the base plate and form a receiving channel for receiving the mating element. The fastening element is therefore pivotably connected to the base support, in particular a sill edge of the base support, by means of the base plate. The base plate can therefore have the joint by means of which the fastening element is pivotably connected to the base support, in particular a sill edge of the base support. For example, the joint can be produced by way of the base plate having a lower material thickness in the connecting region to the base support. The base plate is advantageously cohesively connected to, in particular injection-molded onto, an edge, in particular a sill edge, of the base support. The webs can receive the channel seal between them, so that the fitting strip can be fitted in the channel seal. The webs can have the same length or different lengths.

In one advantageous refinement, the base support and the fastening element are composed of a thermoplastic. In one advantageous refinement, the fastening element is composed of polypropylene (PP) or of a mixture of polycarbonate and acrylonitrile butadiene styrene (PC-ABS).

A further aspect of the invention proposes a vehicle which has at least one cladding part according to the invention.

A vehicle, a cladding part and further features and advantages will be explained in more detail below with reference to exemplary embodiments which are schematically illustrated in the figures.

### BRIEF DESCRIPTION OF THE DRAWINGS

FIG. 1 shows a vehicle with a vehicle door;

FIG. 2 shows a front view of a cladding part for the vehicle door illustrated in FIG. 1, the cladding part having a base support and a fastening element according to a first embodiment;

FIG. 3 shows an enlarged detail of a cross section through the base support and the fastening element along line III-III in FIG. 2 after the injection molding;

FIG. 4 shows an enlarged detail of a cross section through the base support and the fastening element of FIG. 3, the fastening element being pivoted into the fastening position and cohesively connected to the base support; and

FIG. 5 shows an enlarged perspective illustration of a detail of a base support having a fastening element according to a second embodiment.

### DETAILED DESCRIPTION OF THE DRAWINGS

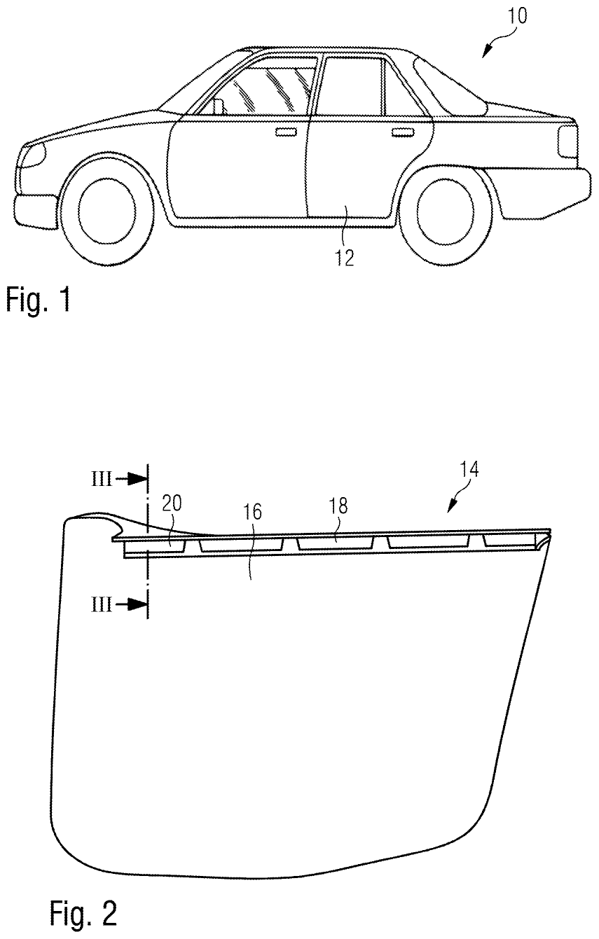

FIG. 1 shows a vehicle 10 with a vehicle door 12. The vehicle 10 has a drive machine designed as an internal combustion engine and/or as an electric motor.

The vehicle door 12 has a cladding part 14, illustrated in FIG. 2, which faces an interior of the vehicle 10.

As can be seen in FIG. 2, the cladding part 14 has a base support 16 and a fastening element 18, by means of which fastening element the cladding part 14 is fastened to a channel seal, not illustrated, which is arranged between an internal door panel, not illustrated, and an external door panel, not illustrated, of the vehicle door 12, as will be explained in more detail below.

The base support 16 is an injection-molded part composed of a thermoplastic, in particular a polypropylene (PP) or a mixture of a polycarbonate and acrylonitrile butadiene styrene (PC-ABS). Further components, not illustrated, of the vehicle door 12, such as door openers, handles, armrests and/or window opener switches for example, are fastened to the base support 16.

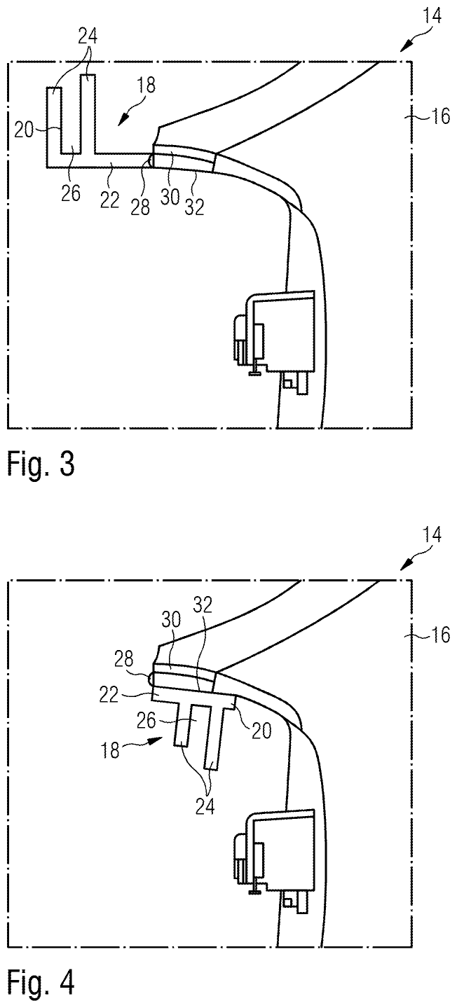

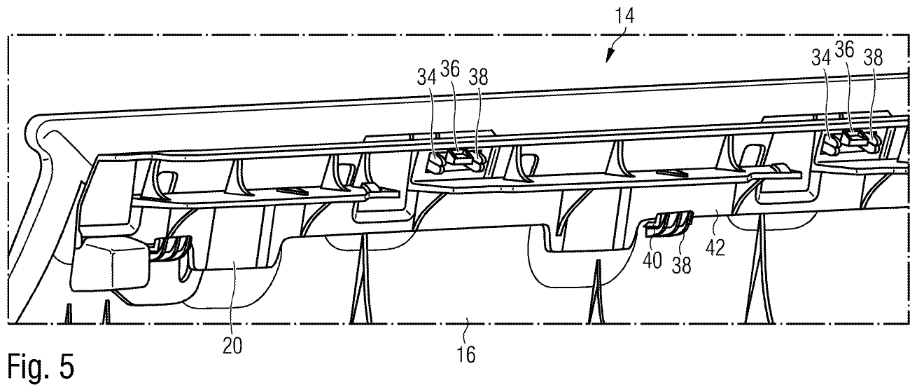

As can be seen in FIGS. 3 and 4 in particular, the fastening element 18 is designed as a fitting strip 20, by means of which the base support 16, in particular the cladding part 14, is fitted in a channel seal, not illustrated, for fastening purposes.

The fitting strip 20 has a base plate 22 and two webs 24, which project from the base plate 22 and form a receiving channel 26 for receiving the channel seal.

As can be gathered by looking at FIGS. 3 and 4 together, the fastening element 18 is pivotably connected to the base support 16. For this purpose, the fastening element 18 has a joint 28, by means of which the fastening element 18 is pivotably connected to the base support 16. As can be seen in FIG. 3 in particular, the fastening element 18 is pivotably connected to a sill edge 30 of the base support 16 by means of the joint 28.

In the present case, the joint 28 is a constituent part of the base plate 22 and has a lower material thickness than the base plate 22, so that the joint 28 forms a bending point or a hinge about which the fastening element 18 is pivoted. The thickness of the sill edge 30 can be adjusted in a vehicle vertical direction, which corresponds to a Z axis, by means of a fold geometry of the fitting strip 20. As a result, the waviness and the stiffness of the cladding part 14 can be adjusted.

The fastening element 14 is cohesively connected to the base support 16, in particular the sill edge 30. For this purpose, the fastening element 18 is injection-molded onto the sill edge 30 of the base support 16. In particular, the fastening element 18, in particular the base plate 22, is injection-molded onto the sill edge 30 in such a way that the fastening element 14 projects perpendicularly from the sill edge 30, as can be seen in FIG. 3. As a result, during the manufacture of the base support 16 and the fastening element 18, no large and complex slides are required in an injection mold, not illustrated, and in addition the base support 16 can be demolded together with the fastening element 18 injection-molded onto it.

In order to fasten the base support 16 to the channel seal, not illustrated, in particular to fit the fitting strip 20 into the channel seal, the fastening element 18 is pivoted or flipped by means of the joint 28, so that the base plate 22 bears against a bottom side 32 of the sill edge 30, as can be seen in FIG. 4. In order that the fastening element 18 or the fitting strip 20 remains in the fastening position illustrated in FIG. 4 and does not pivot back, the base plate 22 is welded to the base support 16, in particular the sill edge 30. For this purpose, the fastening element 18 can be welded to the base support 16, in particular the sill edge 30, by means of ultrasonic, vibration and/or mirror welding.

A base support 16 and a fastening element 18 according to a second embodiment will be explained below, the same reference signs being used for identical or functionally identical parts.

The base support 16 and the fastening element 18 according to the second embodiment differ from the first embodiment in that the fastening element 18 is clipped to the base support 16 in order to maintain the fastening positions after the pivoting or flipping. For this purpose, the fastening element 18 has openings 34 into which first latching means 36, which project from the base support 16, in the form of latching hooks 38 interlockingly and force-fittingly engage. In addition, second latching means 40 in the form of latching hooks 38 project from the base support 16, the second latching means engaging around a bottom edge 42 of the fastening element 18, in particular the fitting strip 20. The first latching means 36 and the second latching means 40 fix the fastening element 18 to the base support 16 in the fastening position.

The cladding part 14 is distinguished in that the fastening element 18 is injection-molded onto the base support 16 in such a way that it can be pivoted into a fastening position. As a result, no slides are required in the injection mold and in addition demolding of the fastening element 18 is possible.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE CHARACTERS

10 Vehicle
12 Vehicle door
14 Cladding part
16 Base support
18 Fastening element
20 Fitting strip
22 Base plate
24 Web
126 Receiving channel
28 Joint
30 Sill edge
32 Bottom side
34 Opening
36 First latching means
38 Latching hook
40 Second latching means
42 Bottom edge

What is claimed is:

1. A cladding part for an interior of a vehicle, comprising:
a base support; and
a fastening element for fastening the base support to a vehicle part of the vehicle, wherein the fastening element is pivotable into a fastening position.

2. The cladding part according to claim 1, wherein the fastening element and/or the base support have/has a joint and wherein the fastening element is pivotably connected to the base support by the joint.

3. The cladding part according to claim 1, wherein the fastening element is injection-molded onto the base support.

4. The cladding part according to claim 1, wherein the fastening element is welded to the base support in the fastening position.

5. The cladding part according to claim 4, wherein the fastening element is welded to the base support by ultrasonic welding, vibration welding, and/or mirror welding.

6. The cladding part according to claim 1, wherein the fastening element is clipped to and/or latched to the base support in the fastening position.

7. The cladding part according to claim 1, wherein the fastening element is a fitting strip for fitting into a mating element of the vehicle part.

8. The cladding part according to claim 7, wherein the fitting strip has a base plate which is pivotably disposed on the base support and has two webs which project from the base plate and which form a receiving channel for receiving the mating element.

9. The cladding part according to claim 1, wherein the fastening element and the base support are composed of a thermoplastic.

10. A vehicle, comprising:
the cladding part according to claim 1.
